(19) United States
(12) Patent Application Publication
(10) Pub. No.: US 2006/0224420 A1
(43) Pub. Date: Oct. 5, 2006

(54) Healthcare insurance security system

(75) Inventor: Richard A. Willis, Arlington, TN (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: APSRFID, LLC

(21) Appl. No.: 11/099,026

(22) Filed: Apr. 5, 2005

(51) Int. Cl. G06F 19/00; G06Q 40/00; G06K 5/00

(52) U.S. Cl. 705/3; 705/4; 235/380; 235/462.46

(57) ABSTRACT

A system that facilitates verifying insurance coverage of an insured includes a radio frequency identification (RFID) card, a card reader system, and an insurance system. The radio frequency identification card is coupled to a patient and is capable of transmitting card data. The card reader system receives the card data from the RFID card and transmits the card data via a communication platform. The insurance system receives the card data from the card reader system via the communication platform and determines whether the insured has insurance coverage based on the card data. The card reader system further transmits data on the type of service provided to the insured to the insurance system, which verifies whether the insured received service from a provider or the provider provided service to the insured based on the received service data from the card reader system.

### TECHNICAL FIELD

The present invention relates to the insurance industry, and more particularly, the embodiments relate to systems, apparatuses, and methods for verifying an insured has insurance coverage, and whether the insured has received service from a provider or whether the provider has provided the service to the insured.

### BACKGROUND OF THE DISCLOSURE

There are a large number of frauds committed in the insurance industry. In one scenario, a provider prescribes a medication to an insured. The prescription is written on paper and the insured makes copies of it. The fraudulent insured takes the copied paper prescription to different drugstores and obtains several amounts of prescribed medications. In another scenario, an insured goes to several different clinics and obtains several paper prescriptions. The fraudulent insured now has several legitimate prescriptions and can obtain the prescribed medication in several different drugstores. In yet another scenario, fraudulent providers can claim that an insured has visited their clinic or drugstore when, in fact, the insured has never visited the clinic or drugstore.

From the above, it can be appreciated that it would be desirable to have a system, apparatus, and method for verifying whether an insured has insurance coverage, and whether the insured has received service from a provider or whether the provider has provided the service to the insured.

### SUMMARY OF THE DISCLOSURE

Disclosed are systems, apparatuses, and methods for verifying whether an insured has insurance coverage, and whether the insured has received service from a provider or whether the provider has provided the service to the insured. In one example, an insurance company issues a radio frequency identification (RFID) card to an insured. The RFID card contains insurance information on the insured and can transmit the information wirelessly. For instance, the insured is experiencing flu-like symptoms and decides to visit a medical clinic. When the insured visits the medical clinic, the insured gives the RFID card to an administrator, which activates the RFID card to transmit card data using a card reader system. The card data includes, but is not limited to, an insurance company's name, the subscriber's name, group name, group identification number, member identification number, member name, the coverage type, the effective date, the office visit co-pay, the emergency co-pay, the pharmacy co-pay, the type of medication, the amount of dosage, the number of medication, the name of medication, the number of refills, and the frequency of taking the medication.

The card reader system in the medical clinic receives the card data from the RFID card and transmits the card data to an insurance system of an insurance provider. The insurance system verifies whether the insured has insurance coverage based on the received card data and transmits the verification data to the card reader system in the medical clinic. The card reader system receives the verification data and informs the administrator whether the insured has insurance coverage. If the insured has no insurance coverage, the insured may be denied any service. If the insured has insurance coverage, the insured is provided service in the medical clinic. The service for flu-like symptoms can include a blood test, a urine test, a diagnosis of the illness, and a recommended medication.

The provider can transmit data on the services provided to the insured to the RFID card using a personal digital assistant (PDA) device. In an alternative embodiment, the provider can enter the service data into the card reader system. In the case of a system using the PDA, when the insured checks out of the medical clinic, the card reader system receives the card data from the RFID card and the service data and transmits the card and service data to the insurance system of the insurance company. In the case of a system without the PDA, when the insured checks out of the medical clinic, the card reader system receives the card data from the RFID card to associate the card data to the service data stored in the card reader system and transmits the card and service data to the insurance system of the insurance company. The insurance system receives the card and service data from the card reader system in the medical clinic and stores the card and service data in memory that the insured has received services from the medical clinic. This enables the system to ensure that the insured actually received service from the medical clinic or to ensure that the medical clinic actually provided service to the insured.

The insurance system determines whether to update card data in the RFID card. If the card data needs to be updated, the insurance system transmits updated card data to the card reader system via the communication platform. If the insurance system makes a determination not to update the card data in the RFID card, the insurance system communicates this information to the card reader system. The card reader system then determines whether to update the data in the RFID card based on the updated card data received from the insurance system. The updated card data can include the insurance information on the insured and information on the prescribed medication. In an alternative embodiment, the card reader system can determine whether to update the card data in the RFID card based on the information from the provider inputted into the card reader system. The information can include information on the prescribed medication. The card reader system transmits the updated card data from the insurance system and/or information from the provider to the RFID card. The RFID card can confirm the updated data with the insurance system via the card reader system and the communication platform before the RFID card stores the updated data into memory.

To obtain the prescribed medication, the insured goes to a drugstore and a card reader system in the drugstore activates the RFID card and receives card data from the RFID card. The card reader system in the drugstore communicates the card data to the insurance system via the communication platform. The insurance system determines whether the insured has insurance coverage. If the insured has no insurance coverage, the insured may be denied any service. If the insured has insurance coverage, the insured is provided service in the drugstore and the medication is distributed.

A pharmacist enters data on the services provided to the insured into the card reader system that the insured received the prescribed medication. When the insured checks out of the drugstore, the card reader system receives the card data from the RFID card to associate the card data to service data and transmits the card and service data to the insurance system of the insurance company. The insurance system receives the service data from the card reader system in the drugstore and stores the service data in memory that the insured received medication from the drugstore. The insurance system can determine whether to update card data in the RFED card, e.g., the remaining number of refills or that the medication has already been obtained.

If the card data needs to be updated, the insurance system transmits updated card data to the card reader system via the communication platform. The card reader system receives the updated card data from the insurance system. If the insurance system determines not to update the card data in the RFID card, the insurance system communicates this information to the card reader system. In an alternative embodiment, the card reader system can determine whether to update the card data in the RFID card based on the information from the provider inputted into the card reader system. In both embodiments, the card reader system transmits the updated card data from the insurance system and/or from the provider to the RFID card. This enables the system to ensure that an insured actually received medication from the drugstore or to ensure that the drugstore actually provided medication to the insured.

### BRIEF DESCRIPTION OF THE DRAWINGS

The disclosed systems, apparatuses, and methods can be better understood with reference to the following drawings. The components in the drawings are not necessarily to scale.

FIG. 1 is a perspective view of an embodiment of a system that verifies whether an insured has insurance coverage, and whether the insured received service from a provider or whether the provider provided the service to the insured.

FIG. 2 is a schematic view of an embodiment of the system shown in FIG. 1.

FIG. 3 is a schematic view of an embodiment of the system shown in FIG. 1.

FIG. 4 is a schematic view of an embodiment of the system shown in FIG. 1.

FIG. 5 is a block diagram of an embodiment of an RFID card of the system shown in FIG. 1.

FIG. 6 is a view of an embodiment of the outside surface of the RFID card shown in FIG. 5.

FIG. 7 is a block diagram of an embodiment of a card reader system shown in FIG. 1.

FIG. 8 is a block diagram of an embodiment of a computing device of the RFID card shown in FIG. 5.

FIG. 9 is a block diagram of an embodiment of a computing device of the card reader system shown in FIG. 7.

FIG. 10 is a block diagram of an embodiment of an insurance system shown in FIG. 1.

FIGS. 11A-B are flow diagrams that illustrate an embodiment of operation of the system shown in FIG. 1 that verifies whether an insured has insurance coverage, and whether the insured received service from a provider or whether the provider provided the service to the insured.

FIG. 12 is a flow diagram that illustrates an embodiment of operation of a RF card manager of a RFID card shown in FIG. 8.

FIG. 13 is a flow diagram that illustrates an embodiment of operation of a card reader manager of a card reader system shown in FIG. 9.

FIG. 14 is a flow diagram that illustrates an embodiment of operation of an insurance manager of an insurance system shown in FIG. 10.

### DETAILED DESCRIPTION OF THE PREFERRED EMBODIMENT

Disclosed herein are systems, apparatuses, and methods to which an insured can be verified whether the insured has insurance coverage, and whether the insured received service from a provider or whether the provider provided the service to the insured. In particular, the insured is coupled with a radio frequency identification card, which transmits card data to a card reader system, preferably located in a drugstore or a medical clinic. The card reader system receives the card data and transmits the card data to an insurance system via a communication platform. The insurance system determines whether the insured is authorized for insurance coverage based on the card data. When the insured checks out of the drugstore and/or medical clinic, the card reader system transmits service data to the insurance system, which verifies that the insured received service from the drugstore and/or medical clinic.

Card data is information that enables the insurance system to verify whether an insured has insurance coverage, and facilitate verifying whether the insured has received service from a provider or whether the provider has provided the service to the insured. For example, the card data can include, but is not limited to, insured name, place of residence, data of birth, coverage type, effective date, member identification number, group identification number, prescribed medication from a medical provider, number of refills for the medication, instructions on taking the medication, the amount of dosage, the frequency of taking the medication, etc. Service data is information that pertains to the type of service that a medical provider has provided to the insured. For example, the service data can include, but is not limited to, a blood test, a urine test, physical check for cold, physical check for flu, medication distribution, etc.

Example systems are first discussed with reference to the figures. Although the systems are described in detail, they are provided for purposes of illustration only and various modifications are feasible. After the exemplary systems have been described, examples of operation of the systems are provided to explain the manner in which the insured can be verified for insurance coverage.

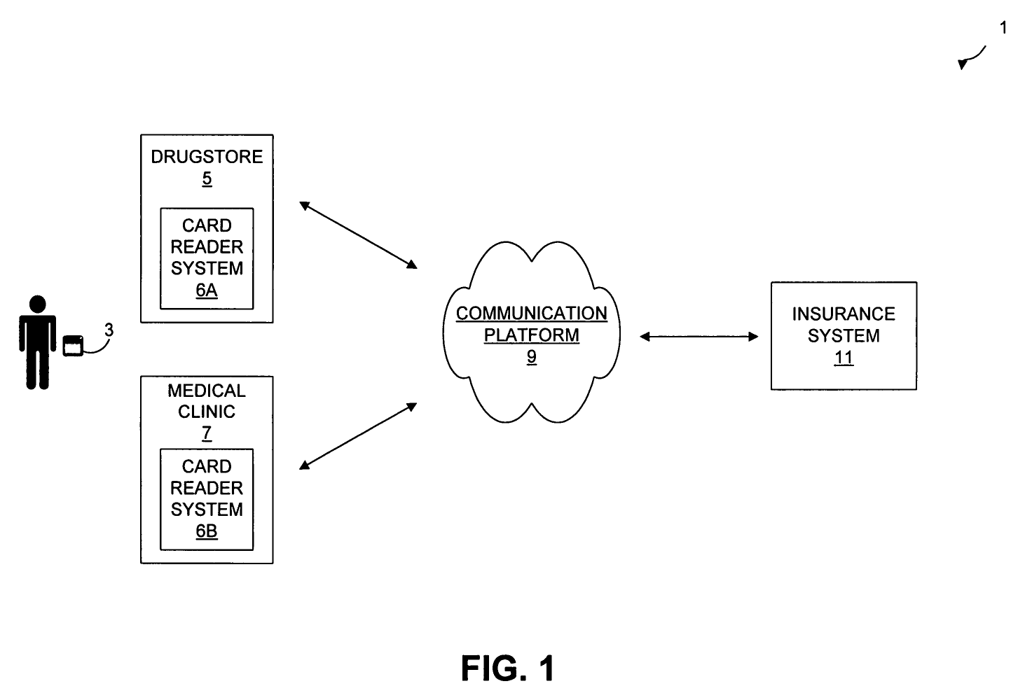

Referring now in more detail to the figures in which like reference numerals identify corresponding parts, FIG. 1 is a perspective view of an embodiment of a system that verifies whether an insured has insurance coverage, and whether the insured received service from a provider or whether the provider provided the service to the insured. The system 1 includes one or more radio frequency identification (RFID) cards 3, one or more personal digital assistant devices 8, one or more card reader systems 6, communication platform 9, and one or more insurance systems 11. An insured is coupled with an RFID card 3, and drugstore 5 and medical clinic 7 are coupled with card reader systems 6A-B. The PDA 8 can transmit data on the service provided to the insured to the RFID card 3. The RFID card 3 communicates with the card reader system 6, which communicates with the insurance system 11 via the communication platform 9. The RFID card 3 can communicate with the insurance system via the card reader system 6 and communication platform 9.

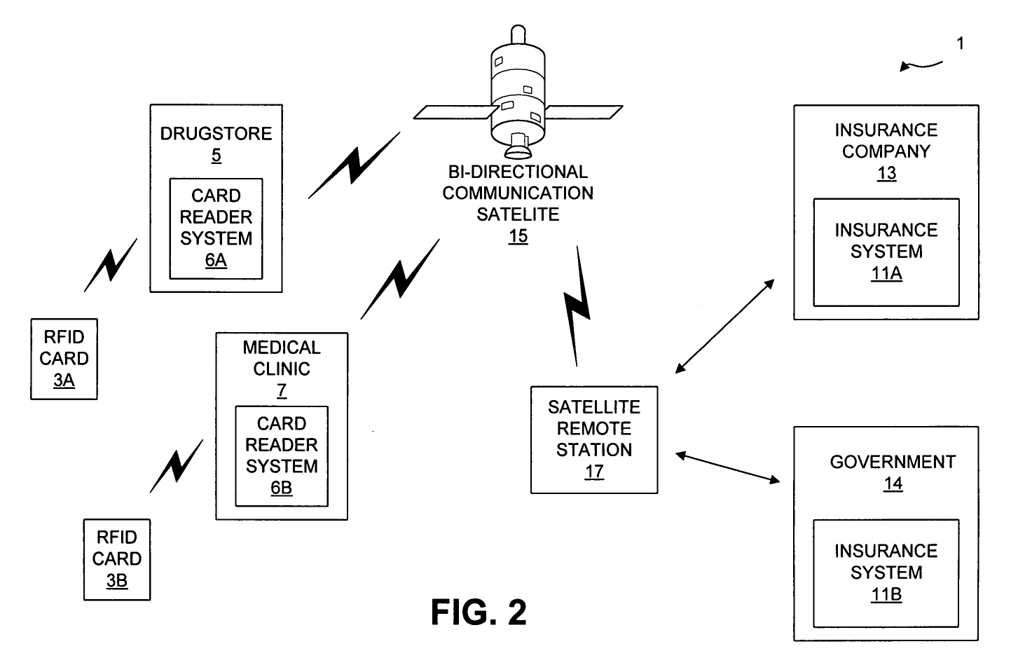

FIG. 2 is a schematic view of an embodiment of the system shown in FIG. 1. The system 1 includes RFID cards 3A-B, drugstore 5 that contains card reader 6A, medical clinic 7 that contains card reader system 6B, a bi-directional communication satellite 15, satellite remote station 17, an insurance company 13 that contains an insurance system 11A, and a government 14 that contains an insurance system 11B. When the insured enters a drugstore 5 and/or medical clinic 7, the card reader system 6 can activate the RFID card 3 to transmit card data. In an alternative embodiment, the RFID card 3 can continuously transmit card data at a predetermined interval, e.g., every 5 seconds.

For purposes of illustration only, the insured that is coupled to the RFID card 3A has insurance coverage with insurance company 13 and the insured that is coupled to RFID card 3B has insurance coverage with the government 14. As shown in FIG. 2, the RFID card 3A transmits data to the card reader system 6A of the drugstore 5. The card reader system 6A not only receives card data but also input from a medical provider on the type of service that the insured has received in a drugstore 5. The card reader system 6A transmits the card data and the service input to insurance system 11A of insurance company 13 via the bi-directional communication satellite 15 and satellite remote station 17.

The RFID card 3B transmits to the card reader system 6B of the medical clinic 7 and a medical provider inputs a type of service that an insured has received into the card reader system 6B. The card reader system 6B transmits the card data and the service input to the insurance system 11B of the government 14 via bi-directional communication satellite 15 and satellite remote station 17. The card data from the RFID card 3 and the service input from the provider facilitates the insurance system 11 to verify whether the insured has insurance coverage and whether the insured received service from the drugstore 5 and/or medical clinic 7.

It should be noted that the card reader systems 6A-B can receive data both from the RFID cards 3A-B and transmit the card data to either insurance system 11A of insurance company 13 or insurance system 11B of the government 14 depending on the card data. For example, if the insured that is coupled to RFID card 3A is insured with insurance company 13, the card data from the RFID card 3A contains the address code of the insurance company that will enable the card reader system 6B of the medical clinic 7 to transmit the card data to the insurance system 11A of the insurance company 13 via bi-directional communication satellite 15 and satellite remote station 17.

It should also be noted that the card data in the RFID card 3 can be updated by the card reader system 6. For example, the medical provider can prescribe medication to the insured. The medical provider inputs the information on the medication into the card reader system 6, which transmits the medication information to the RFID card 3. The information for the prescribed medication can include, but is not limited to, the name of the medication, the dosage of the medication, the number of medication being distributed, the number of refills, the type of medication, etc. The insured takes the RFID card 3 to the drugstore 5 and obtains the prescribed medication from a pharmacist using the RFID card 3. The card reader system 6 can transmit the information on the prescribed medication to the insurance system 11. The information for the prescribed medication enables the insurance system 11 to verify whether the insured has insurance coverage for the medication, whether the insured is authorized to receive the medication by a provider, and whether the insured has received the medication from a pharmacist.

In another example, the card reader system 6 can receive data from the insurance system 11 and update the RFID card 3 with the data. The data from the insurance system 11 that updates the card data in the RFID card 3 can include insurance information such as, effective date, type of insurance coverage, change the name of the insured, prescribed medication, etc., and medication information as mentioned above.

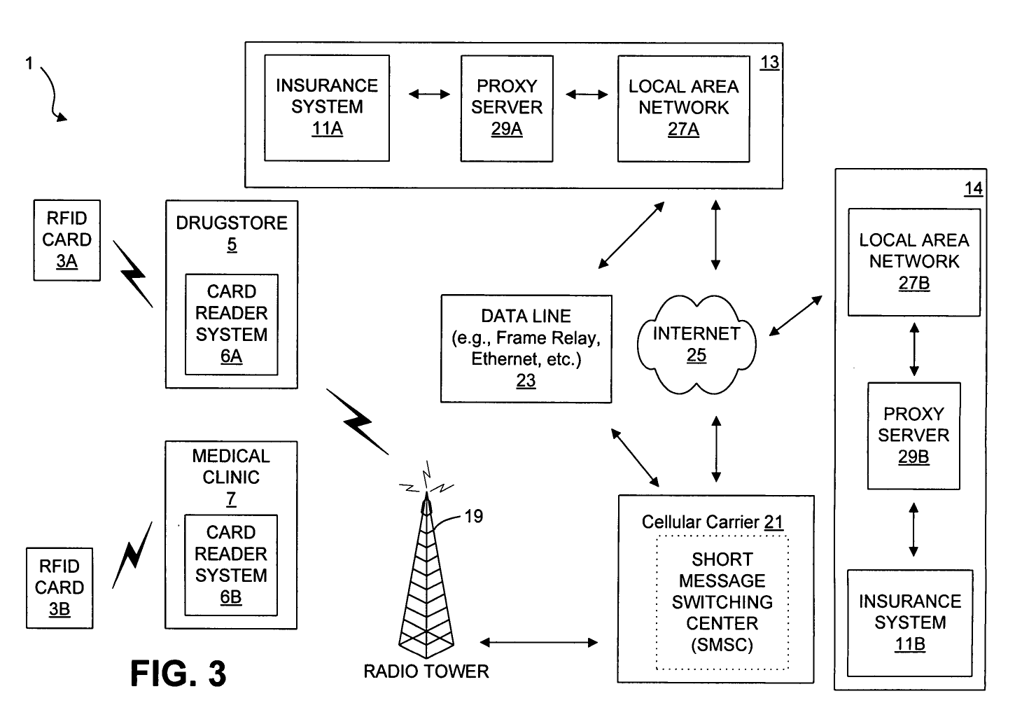

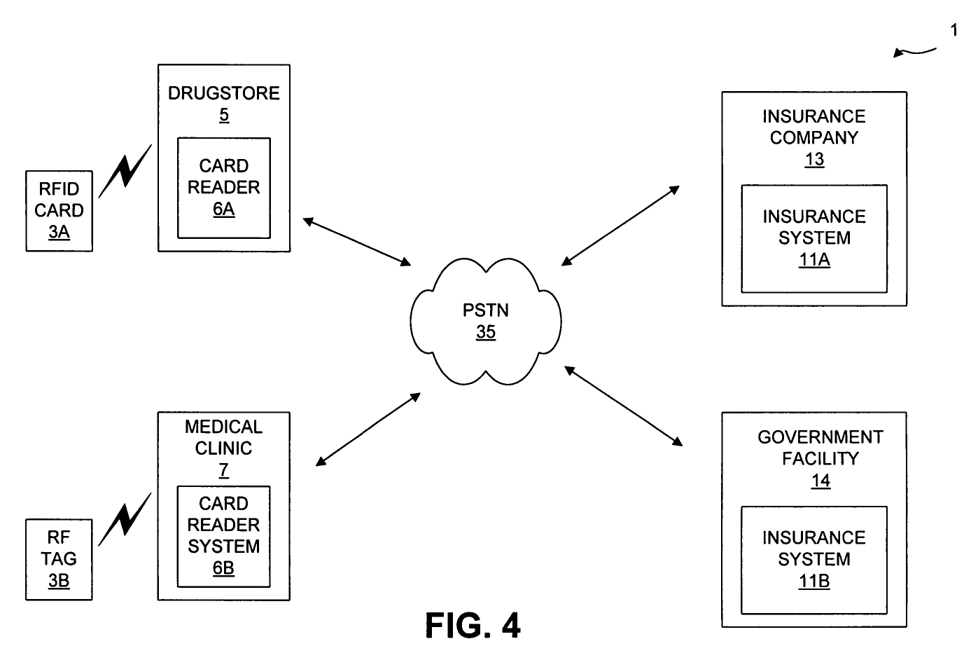

FIG. 3 is a schematic view of an embodiment of a system shown in FIG. 1. FIG. 3 illustrates one embodiment of the communication platform 9 to facilitate communications between the card reader systems 6A-B and insurance systems 11A-B and between RFID cards 3A-B and insurance systems 11A-B using radio tower 19, cellular carrier 21, data line 23, Internet 25, local area networks 27A-B, and proxy servers 29A-B. FIG. 4 is a schematic view of an embodiment of the system shown in FIG. 1. FIG. 4 illustrates one embodiment of the communication platform 9 to facilitate communication between the card reader systems 6A-B and insurance systems 11A-B using a public switch telephone network 35.

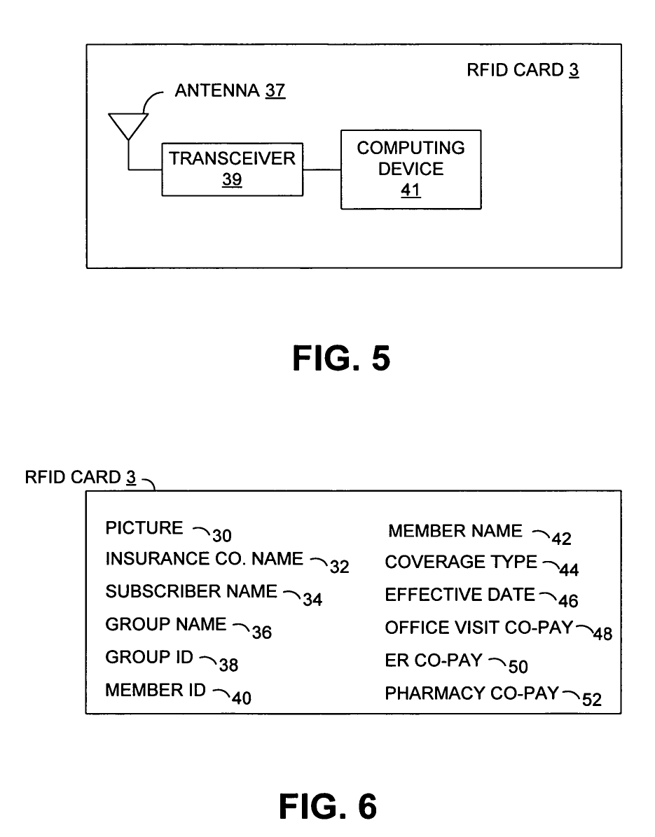

FIG. 5 is a block diagram of an embodiment of an RFID card shown in FIG. 1. The RFID card 3 includes an antenna 37, transceiver 39, and computing device 41. The antenna 37 receives and transmits data from and to a card reader system 6. The antenna 37 is electrically coupled to transceiver 39, which is electrically coupled to computing device 41. The transceiver 39 receives data from the antenna 37 and converts the data from analog to digital format. For example, the card reader system 6 can transmit an activation signal to the RFID card 3 to transmit card data. The antenna 37 receives the activation signal and sends it to the transceiver 39, which converts the signal from analog to digital format. The transceiver 39 sends the digital activation signal to the computing device, which enables the RFID card 3 to transmit card data based on the activation signal.

The computing device 41 communicates to the card reader system 6 via the antenna 37 and transceiver 39. For example, after the computing device 41 receives the activation signal from the card reader system 6, the computing device 41 sends card data to the transceiver 39. The transceiver 37 converts the card data from digital to analog format. The transceiver 37 sends the analog card data to the antenna 37, which transmits the analog card data to the card reader system 6. The card data enables the system 1 to verify whether the insured has insurance coverage, and whether the insured received service from a provider or the provider provided service to the insured. It should be noted that the computing device 41 can communicate with the insurance system 11 via the card reader system 6 and the communication platform 9.

FIG. 6 is a view of the outside surface of the RFID card shown in FIG. 5. The outer surface of the RFID card 3 can contain, but is not limited to, a picture of the insured 30, the insurance company name 32, the subscriber name 34, the group name 36, the group ID 38, member ID 40, member name 42, coverage type 44, effective date 46, office visit co-pay 48, emergency co-pay 50, and pharmacy co-pay 52. It should be noted that the card data contained in memory of the RFID card 3 can contain the information that is on the outer surface of the RFID 3 as explained in relation to FIG. 6.

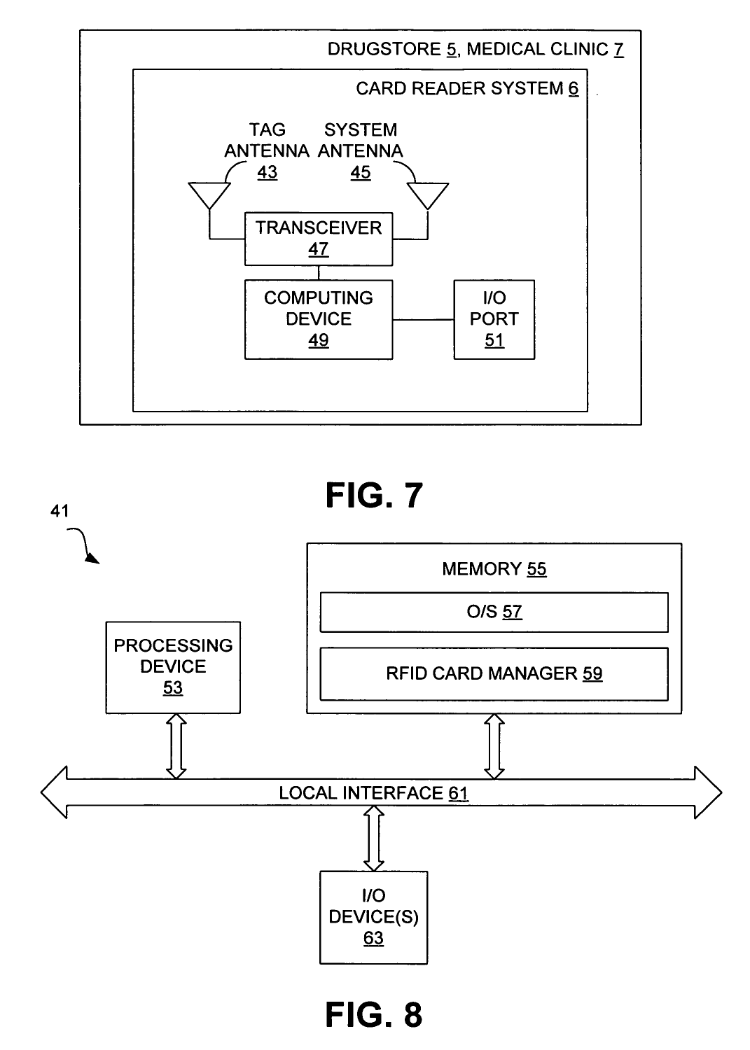

FIG. 7 is a block diagram of an embodiment of the card reader system 6 shown in FIG. 2. The card reader system 6 includes a tag antenna 43, system antenna 45, transceiver 47, computing device 49, and input/output (I/O) port 51. The tag antenna 43 and system antenna 45 are electrically coupled to the transceiver 47, which is electrically coupled to the computing device 49. The tag antenna 43 of the card reader system 6 receives and transmits data from and to the RFID card 3. Similar to the transceiver 39 of the RFID card 3, the transceiver 47 can convert data from the antennas 43, 45 from analog to digital format, and vice versa from data received from the computing device 49. The computing device 49 is electrically coupled to the I/O port 51.

The computing device 49 communicates the card data from the RFID card 3 to the insurance system 11 via the system antenna 45 or the I/O port 51. The system antenna 45 wirelessly receives and transmits data to and from insurance system 11 via the communication platform 9. The computing device 49 can be electrically coupled to a network by way of the I/O port 51 to communicate to the insurance system 11. It should be noted that the card reader system 6 can communicate to the insurance system 11 wirelessly or wired via system antenna 45 and I/O port 51, respectively.

FIG. 8 is a block diagram of an embodiment of a computing device 41 of the RFID card 3 shown in FIG. 5. As indicated in FIG. 8, the computing device 41 comprises a processing device 53, memory 55, and one or more I/O devices 63, each of which is connected to a local interface 61. The processing device 53 can include any custom made or commercially available processor, a central processing unit (CPU) or an auxiliary processor among several processors associated with the computing device 41, a semiconductor based microprocessor (in the form of a microchip), or a macroprocessor. The memory 55 can include any one or a combination of volatile memory elements (e.g., random access memory (RAM, such as DRAM, SRAM, etc.)) and nonvolatile memory elements (e.g., ROM, hard drive, tape, CDROM, etc.).

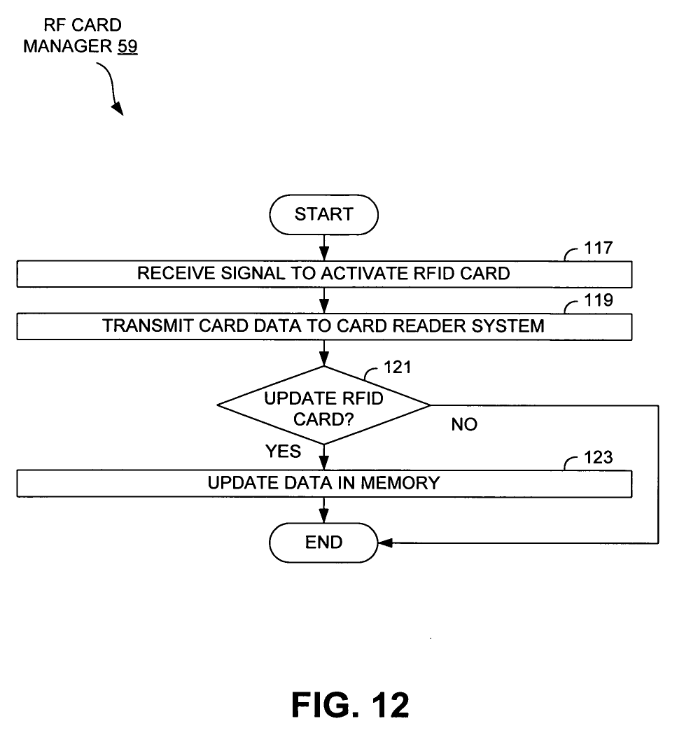

The one or more I/O devices 63 comprise components used to facilitate connection of the computing device 41 to other devices and therefore, for instance, comprise one or more serial, parallel, small system interface (SCSI), universal serial bus (USB), or IEEE 1394 (e.g., Firewire™) connection elements. The memory 55 normally comprises various programs (in software and/or firmware) including an operating system (O/S) 57 and RFID card manager 59. The O/S 57 controls the execution of programs, including the RFID card manager 59, and provides scheduling, input-output control, file and data management, memory management, and communication control and/or related services. The RFID card manager 59 facilitates verifying whether an insured has insurance coverage, and whether the insured received service from a provider or the provider provided service to the insured. Typically, the RFID card manager 59 receives an activation signal from a card reader system 6 and transmits card data to a card reader system 6, which transmits the card data to an insurance system. Operation of the RFID card manager 59 is described in relation to FIG. 12.

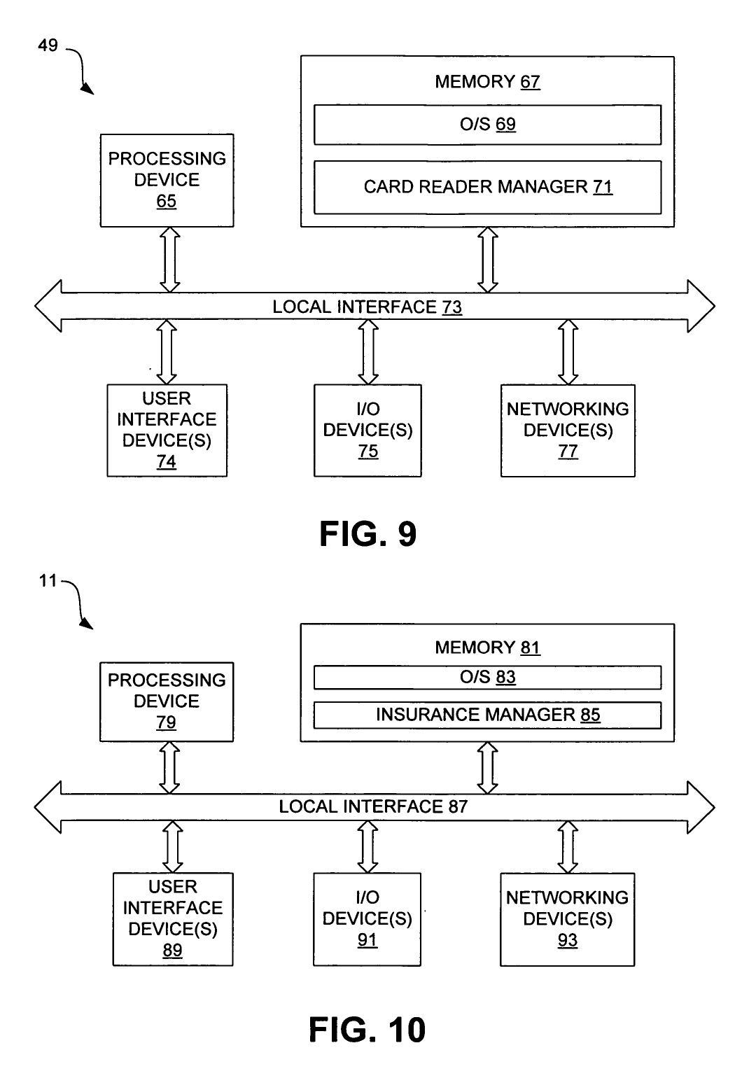

FIG. 9 is a block diagram of an embodiment of a computing device of the card reader system shown in FIG. 7. The architecture for the computing device 49 is similar to the architecture of the computing device 41 of the RFID card 3 described above and therefore includes a processing device 65, and one or more I/O devices 75, each of which is connected to a local interface 73.

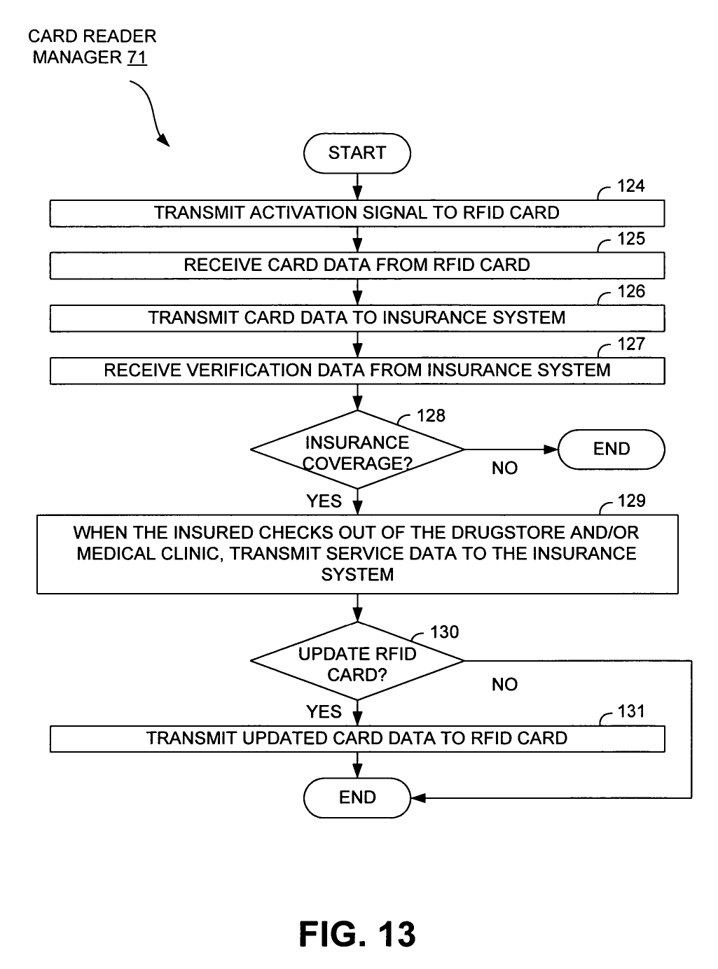

The memory 67 in the card reader system 6, however, includes a card reader manager 71 that facilitates verifying whether an insured has insurance coverage, and whether the insured received service from a provider or the provider provided service to the insured. Typically, the card reader manager 71 receives card data from the RFID card 3 and input from a provider on a type of service that an insured has received. The card reader manager 71 transmits the card data and service data to an insurance system 11. Operation of the card reader manager 71 is described in relation to FIG. 13.

The architecture for the computing device 49 of the card reader system 6 further includes one or more networking devices 77 and one or more user interface devices 74. The networking devices 77 comprise the various components used to transmit and/or receive data over the communication platform 9, where provided. By way of example, the networking devices 77 include a device that can communicate both inputs and outputs, for instance, a modulator/demodulator (e.g., modem), a radio frequency (RF) or infrared (IR) transceiver, a telephonic interface, a bridge, a router, as well as a network card, etc. The one or more user interface devices 74 comprise those components with which the user (e.g., administrator) can interact with the card reader system 6. Where the card reader system 6 comprises a server computer or similar device, these components can comprise those typically used in conjunction with a PC such as a keyboard and mouse.

FIG. 10 is a block diagram of an embodiment of an insurance system 11 of the system shown in FIG. 1. The architecture for the insurance system 11 is similar to the architecture of the computing device 49 of the card reader system 6 described above and therefore includes a processing device 79, one or more networking devices 93, one or more user interface devices 89, and one or more I/O devices 91, each of which is connected to a local interface 87.

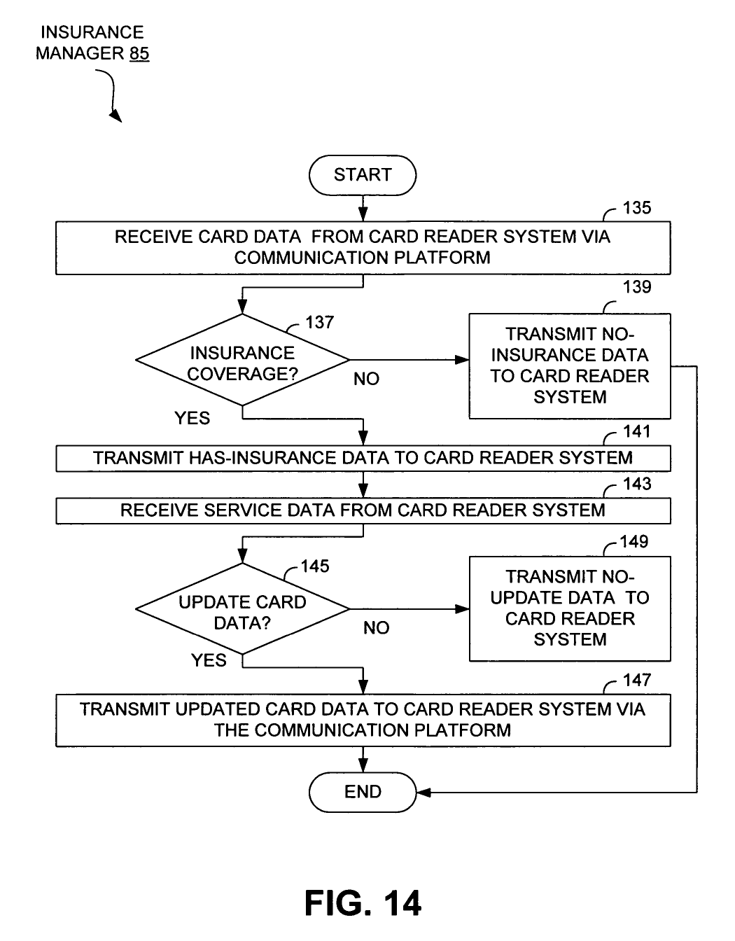

The memory 81 in the insurance system 11, however, includes an insurance manager 85 that facilitates verifying whether an insured has insurance coverage, and whether the insured received service from a provider or the provider provided service to the insured. Typically, the insurance manager 85 receives card data and service data from the card reader system 6. The insurance manager 85 uses the card data and services to verify whether the insured has insurance coverage and verify whether the insured received service from a drugstore 5 and/or medical clinic 7. Operation of the insurance manager 85 is described in relation to FIG. 14.

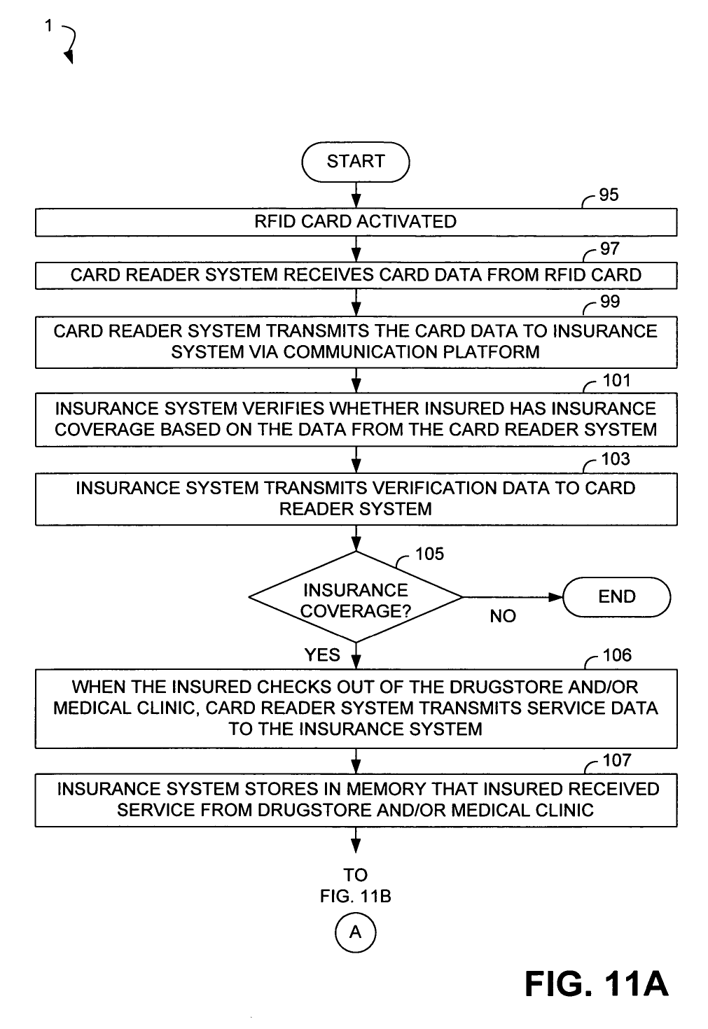

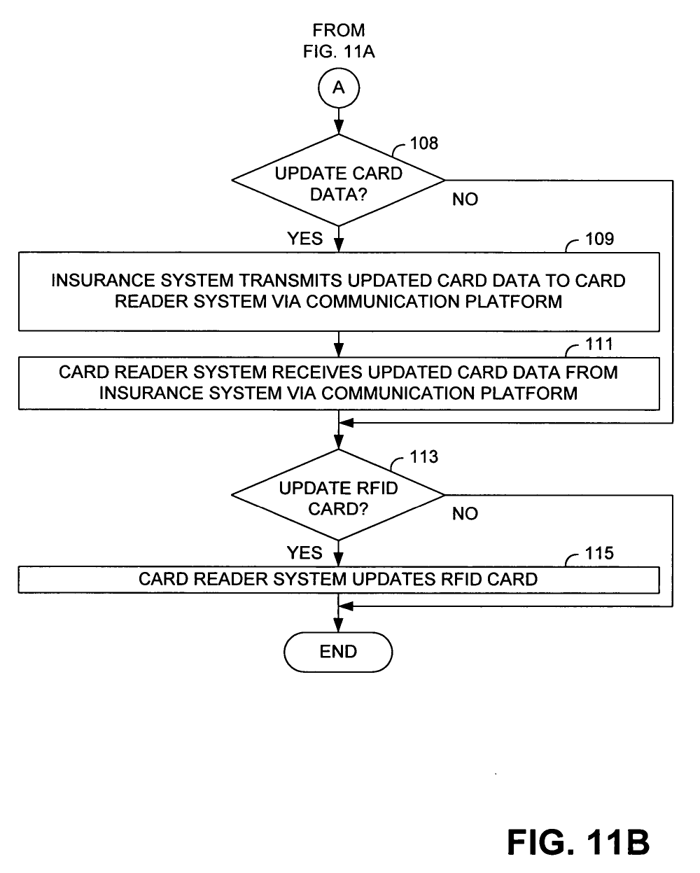

FIGS. 11A-B are flow diagrams that illustrate an embodiment of operation of the system shown in FIG. 1 in verifying whether an insured has insurance coverage, and whether the insured received service from a provider or the provider provided service to the insured. Beginning with block 95, the radio frequency identification card is activated to transmit card data. The RFID card 3 contains card data in memory 55 that includes, but is not limited to, an insurance company's name, the subscriber's name, group name, group identification number, member identification number, member name, the coverage type, the effective date, the office visit co-pay, the emergency co-pay, the pharmacy co-pay, the type of medication, the amount of dosage, the number of medication, the name of medication, the number of refills, and the frequency of taking the medication.

The RFID card 3 can receive an activation signal from a card reader system 6 to transmit the card data. The card reader system 6 receives the card data from the RFID card 3, as indicated in block 97. In an alternative embodiment, the card reader system 6 can associate the card data to a provider, time, and date so that the system 1 can track the insured being provided with service from a provider or the provider providing service to the insured. The card reader system 6 transmits the card data to an insurance system 11 via a communication platform 9, as indicated in block 99. For example, in a medical clinic, the card reader system 6B receives insurance information from the RFID card to facilitate verifying whether the insured has insurance coverage for the visitation. A provider may prescribe medication to the insured and can use the card reader system 6 to transmit the prescribed medication to the RFID card 3. In an alternative embodiment, the provider can transmit the prescribed medication to the RFID card 3 using a PDA 8. When the insured obtains the prescribed medication from a drugstore, the card reader system 6A receives card data including insurance and prescription information from the RFID card 3 to facilitate verifying whether the insured has insurance coverage for the medication. In an alternative embodiment, the card reader system 6 also transmits the associated data to the insurance system 11.

The insurance system 11 receives the card data and verifies whether the insured has insurance coverage based on the data from the card reader system, as indicated in block 101. In the case where the insurance system 11 receives the associated data, the insurance system 11 tracks the insured being provided with service from a provider or the provider providing service to the insured, e.g, the number of times the insured received service, the number of times the provider provided service to the insured, when the services was received/provided, etc. The insurance system 11 transmits verification data to the card reader system 6 via the communication platform 9, as indicated in block 103. The card reader system 6 receives the verification data and displays the data on a display device to a provider whether the insured has insurance coverage, as indicated block 105. If the insured has no insurance coverage, a provider informs the insured that he/she has no insurance coverage. If the insured has insurance coverage, the provider provides service to the insured.

When the insured checks out of a drugstore 5 and/or medical clinic 7, the card reader system 6 transmits data containing the type of service provided to the insured to the insurance system 11, as indicated in block 106. For example, the type of service in a medical clinic can be a yearly routine checkup, a physical, an illness, a mammogram, an emergency injury, prescribed medication, etc. The type of service in a drugstore can be, but is not limited to, obtaining medication and refilling a medication. For example, the card reader system 6 in a medical clinic can transmit data on the medication that the provider prescribed to the insured to the insurance system 11. This enables the insurance system 11 to verify that a provider actually prescribed the medication when the insured requests to receive the medication from a drugstore. In an alternative embodiment, the card reader system 6 can be required to communicate with the RFID card 3 before transmitting the service data to the insurance system 11 during check out. This further enables the system to ensure that an insured actually received service from the provider or to ensure that a provider actually provided service to an insured.

In block 107, the insurance system 11 receives the service data from the card reader system 6 and stores the service data in memory that the insured received service from the drugstore 5 and/or medical clinic 7. Referring to FIG. 11B reference A, in block 108, the insurance system 11 determines whether to update card data in the RFID card 3. If the card data needs to be updated, the insurance system 11 transmits updated card data to the card reader system 6 via the communication platform 9, as indicated in block 109. The card reader system 6 receives updated card data from the insurance system 11, as indicated in block 111. If the insurance system 11 determines not to update the card data in the RFID card 3, the insurance system 11 communicates this information to the card reader system 6.

The card reader system, in block 113, determines whether to update the data in the RFID card 3 based on the updated card data received from the insurance system 11. For example, the insurance system 11 can transmit to the RFID card 3 updated data on the name of the insured, effective date, co-payment cost, member identification, type of prescribed medication, number of refills for the medication, etc. In an alternative embodiment, the card reader system 6 can also determine whether to update the card data in the RFID card 3 based on data received from the provider entered into the card reader system 6. For example, if the provided inputs into the card reader system 6 that the insured is being prescribed with a particular medication, the card reader system 6 can transmit information on the prescribed medication to the RFID card 3.

In an alternative embodiment, the card reader system 6 can update the RFID card 3 without receiving updated data from the insurance system 11 to update the RFID card 3. In block 115, the card reader system 6 transmits the updated card data from the insurance system 11 and/or from the provider to the RFID card 3, which stores the updated data into its memory 55. The system 1 can enable the insurance companies to speed payment to the providers because the system 1 ensures that the insured actually received service from the provider or, in other words, the provider actually provided service to the insured.

FIG. 12 is a flow diagram that illustrates an embodiment of operation of the RF card manager shown in FIG. 8. Beginning with block 117, the RF card manager 59 receives signal to activate the RFID card 3 from the card reader system 6. In an alternative embodiment, the RFID card manager 59 can receive service data from a PDA 8. In block 119, the RF card manager 59 transmits card data to the card reader system 6. In block 121, the RF card manager 59 determines whether the RFID card 3 receives updated card data. The RF card manager 59 can receive updated card data from the card reader system 6 and/or insurance system 11. For example, the insurance system 11 can update the card data in the RFID card 3 in relation to insurance information, e.g., an insurance company's name, the subscriber's name, group name, group identification number, member identification number, member name, the coverage type, the effective date, the office visit co-pay, the emergency co-pay, the pharmacy co-pay, etc. The card reader system 6 can update the card data in relation to medication prescribed to the insured, e.g., the type of medication, the amount of dosage, the number of medication, the name of the medication, the number of refills, the frequency of taking the medication, etc. If the RF card manager 59 receives updated card data, the RF card manager 59 updates data in memory of the RFID card, as indicated in block 123.

FIG. 13 is a flow diagram that illustrates an embodiment of operation of the card reader manager 71 shown in FIG. 9. Beginning with block 124, the card reader manager 71 transmits an activation signal to the RFID card 3 so the RFID card 3 transmits card data. In block 125, the card reader manager 71 receives card data from the RFID card 3. In an alternative embodiment, the card reader manager 71 can associate the card data to a provider, time, and date so that the system 1 can track the insured being provided with service from a provider or the provider providing service to the insured. In block 126, the card reader manager 71 transmits the card data to the insurance system 11 via communication platform 9. In an alternative embodiment, the card reader manager 71 also transmits the associated data to the insurance system 11.

In block 127, the card reader manager 71 receives verification data from the insurance system 11 via the communication platform 9. In block 128, the RF reader manager 71 displays the verification data on the display device of the card reader system, which enables a provider to determine whether the insured has insurance cover. If the insured has no insurance coverage, the provider informs the insured that he/she has no insurance coverage. If the insured has insurance coverage, the provider may provide service to the insured.

When the insured checks out of a drugstore 5 and/or medical clinic 7, the card reader manager 71 transmits data containing the type of service provided to the insured to the insurance system 11, as indicated in block 129. The card reader manager 71, in block 130, determines whether to update the data in the RFID card 3 based on the updated card data received from the insurance system 11. In an alternative embodiment, the card reader system 6 can also determine whether to update the card data in the RFID card 3 based on data received from the provider entered into the card reader system 6. In block 131, the card reader manager 71 transmits the updated card data from the insurance system 11 and/or from the provider to the RFID card 3. For example, the card reader manager 71 can transmit information on a prescribed medication provided by a provider to the RFID card 3. The card reader manager 71 can transmit insurance information on the insured from the insurance system 11 to the RFID card 3.

FIG. 14 is a flow diagram that illustrates an embodiment of operation of an insurance manager 85 of the insurance system 11 shown in FIG. 1. Beginning with block 135, the insurance manager 85 receives card data from the card reader system 6 via the communication platform 9. In the case where the insurance manager 85 receives associated data, the insurance manager 85 tracks the insured being provided with service from a provider or the provider providing service to the insured. In block 137, the insurance manager 85 determines whether the insured has insurance coverage based on the received data from the card reader system 6. If the insured does not have insurance coverage, the insurance manager 85 transmits no-insurance data to the card reader system 6, as indicated in block 139. If the insured has insurance coverage, the insurance manager 85 transmits has-insurance data to the card reader system 6, as indicated in block 141.

In block 143, the insurance manager 85 receives the service data from the card reader system 6 and stores the service data in memory that the insured received service from the drugstore 5 and/or medical clinic 7. In block 145, the insurance manager 85 determines whether to update card data in the RFID card 3. If the card data needs to be updated, the insurance system transmits updated card data to the card reader system 6 via the communication platform 9, as indicated in block 147. If the insurance manager 85 determines not to update the card data in the RFID card 3, the insurance manager 85 communicates this information to the card reader system 6, as indicated in block 149.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A system that facilitates verifying insurance coverage of an insured, the system comprising:
a radio frequency identification (RFID) card that is coupled to a patient and is capable of transmitting card data; and
a card reader system that receives the card data from the RFID card and transmits the card data via a communication platform; and
an insurance system that receives the card data from the card reader system via the communication platform and determines whether the insured has insurance coverage based on the card data.

2. The system of claim 1, wherein the RFID card is passive that is triggered by the card reader system to transmit the card data.

3. The system of claim 1, wherein the RFID card is active that transmits card data.

4. The system of claim 1, wherein the RFID card comprises:
a computing device that stores card data and prescription data;
a transceiver that is electrically coupled to the computing device, the transceiver being capable of receiving data from the computing device and converting the data from digital to analog; and
an antenna that is electrically coupled to the transceiver, the antenna being capable of transmitting data from the computing device to the card reader system and receiving data from the card reader system,
wherein the transceiver receives the data from the card reader system via the antenna, converts the data from analog to digital, and sends the data to the computing device.

5. The system of claim 4, wherein the RFID card comprises a housing that houses the antenna, transceiver, and computing device, wherein the outside surface of the housing includes one of a picture of the insured; the name of the insured, the insured insurance identification number, the insured insurance policy number, effective date, and the type of insurance coverage.

6. The system of claim 1, wherein the card data contains one of the name of the insured, the insured insurance identification number, the insured insurance policy number, effective date, and the type of insurance coverage.

7. The system of claim 1, wherein the card reader system comprises:
a computing device that stores card data and prescription data;
a transceiver that is electrically coupled to the computing device, the transceiver being capable of receiving data from the computing device and converting the data from digital to analog; and
an antenna that is electrically coupled to the transceiver, wherein the transceiver receives the data from the card reader system via the antenna, converts the data from analog to digital, and sends the data to the computing device, the antenna being capable of transmitting and receiving data from the computing device to and from the insurance system and RFID card.

8. The system of claim 1, wherein the card reader system is located in a first location, the card reader system being capable of associating the card data to one of a provider, time, and date, and transmitting the card data and associated data to the insurance system.

9. The system of claim 8, wherein the first location is one of a medical clinic and a drugstore.

10. The system of claim 1, wherein the insurance system tracks the number of times the insured uses the insurance coverage based on the data received from the RFID card.

11. The system of claim 1, wherein the insurance system is located in a second location, the insurance system being capable of associating the card data to one of a time, and date when the insurance system received the card data.

12. The system of claim 1, wherein the insurance system transmits signal that the insured has or has no insurance coverage for medical service based on the card data.

13. The system of claim 12, wherein the card reader system receives the signal that the insured has or has no insurance coverage for medical service and displays the signal on a display device of the card reader system.

14. The system of claim 1, where the insurance system transmits updated signal to RFID card via communication platform.

15. The system of claim 1, wherein the card reader system transmits an activating signal to the RFID card instructing the RFID card to transmit the card data.

16. The system of claim 1, wherein the communication platform is one of bi-directional satellite communication, Internet protocol communication, cellular communication, public switched telephone network, and short message network communication.

17. The system of claim 1, wherein the card reader system transmits data on the type of service provided to the insured to the insurance system.

18. The system of claim 17, wherein the insurance system verifies whether the insured received service from a provider or the provider provided service to the insured based on the received service data from the card reader system.

19. A insurance system that facilitates verifying insurance coverage of an insured, the insurance system comprising:
a processing device; and
a memory having an operating system and an insurance manager, the processing device interacting with the memory to facilitate the operating system in controlling the execution of at least the insurance manager,
wherein the insurance manager stored in a computer-readable medium, the manager comprising:
logic configured to receive data from a card reader system and;
logic configured to determine whether the insured is authorized for insurance coverage based on the card data from an RFID card.

20. The insurance system of claim 19, wherein the card data contains one of the name of the insured, the insured insurance identification number, the insured insurance policy number, and the type of insurance coverage.

21. The insurance system of claim 19, wherein the insurance manager further comprises logic configured to track the number of times the insured uses the insurance coverage based on the data received from the RFID card.

22. The insurance system of claim 19, wherein the insurance manager further comprises logic configured to associate the card data to one of a time, and date when the insurance system received the card data.

23. The insurance system of claim 19, wherein the insurance manager further comprises logic configured to transmit signal that the insured has or has no insurance coverage for medical service based on the card data.

24. The insurance system of claim 19, wherein the insurance manager receives data on the type of service provided to the insured from the card reader system.

25. The insurance system of claim 24, wherein the insurance manager verifies whether the insured received service from a provider or the provider provided service to the insured based on the received service data from the card reader system.

26. A card reader system that facilitates verifying insurance coverage of an insured, the card reader system comprising:
a processing device; and
a memory having an operating system and a card reader manager, the processing device interacting with the memory to facilitate the operating system in controlling the execution of at least the card reader manager,
wherein the card reader manager stored in a computer-readable medium, the manager comprising:
logic configured to receive card data from a radio frequency identification (RFID) card;
logic configured to transmit the card data to an insurance system via a communication platform;
logic configured to receive a signal from the insurance system via the communication platform that the insured has or has no insurance coverage for medical service based on the card data; and
logic configured to display the signal from the insurance system on a display device.

27. The card reader system of claim 26, wherein the card data contains one of the name of the insured, the insured insurance identification number, the insured insurance policy number, and the type of insurance coverage.

28. The card reader system of claim 26, wherein the card reader manager further comprises logic configured to associate the card data to one of a provider, time, and date, and transmitting the card data and associated data to the insurance system.

29. The card reader system of claim 26, wherein the card reader manager further comprises logic configured to transmit an activating signal to the RFID card instructing the RFID card to transmit the card data

30. The card reader system of claim 26, wherein the card reader manager further transmits data on the type of service provided to the insured to the insurance system that verifies whether the insured received service from a provider or the provider provided service to the insured based on the received service data from the card reader system.

31. A method for verifying insurance coverage of a insured, the method comprising:
activating radio frequency identification (RFID) card;
transmitting card data from the RFID card;
receiving the card data via a card reader system;
transmitting the card data to an insurance system via a communication platform; and
determining whether the insured is authorized for insurance coverage based on the card data.

32. The method of claim 31, further comprising associating the card data to one of a provider, time, date, and room by the card reader system.

33. The method of claim 31, further comprising transmitting an activating signal to the RFID card that instructs the RFID card to transmit the card data.

34. The method of claim 31, further comprising tracking the number of times the insured uses the insurance coverage based on the card data.

35. The method of claim 31, further comprising associating the card data to one of a time, and date when the insurance system received the card data.

36. The method of claim 31, further comprising transmitting signal that the insured has or does not have insurance coverage for medical service based on the card data.

37. The method of claim 31, further comprising receiving the signal that the insured has or does not have insurance coverage for medical service based on the card data and displaying the signal on a display device of a card reader system.

38. The method of claim 31, further comprising receiving data on the type of service provided to the insured.

39. The method of claim 38, further comprising verifying whether the insured received service from a provider or the provider provided service to the insured based on the received service data from the card reader system.
